(19) United States
(12) Patent Application Publication
(10) Pub. No.: US 2003/0014742 A1
(43) Pub. Date: Jan. 16, 2003

(54) Technique for compiling computer code to reduce energy consumption while executing the code

(75) Inventors: Anil Seth, Kanpur (IN); Ravindra B. Keskar, Bangalore (IN); R. Venugopal, Bangalore (IN)

Correspondence Address: Schwegman, Lundberg,, Woessner & Kluth, P.A., P.O. Box 2938, Minneapolis, MN, 55402, US

(73) Assignee: Sasken Communication Technologies Limited

(21) Appl. No.: 10/087,296

(22) Filed: Mar. 1, 2002

Related U.S. Application Data
(60) Provisional application No. 60/303,836, filed on Jul. 9, 2001.

(51) Int. Cl. G06F 9/45

(52) U.S. Cl. 717/158

(57) ABSTRACT

The present invention provides a technique for reducing power consumption during execution of computer code including power-down instructions, while satisfying user-specified real-time constraints on a microprocessor. In one example embodiment, this is accomplished by identifying one or more potential locations in the computer code where the power-down instructions can be inserted. The identified potential locations are then analyzed to select the locations to insert the power-down instructions based on user-specified real-time constraints so that the inserted power-down instructions reduces power consumption without significantly increasing the execution time of the computer code.

### FIELD OF THE INVENTION

This invention generally relates to energy-aware compilers used in compiling computer code, and more particularly to an optimization technique for compiling computer code to reduce energy consumption during execution of the computer code, including power-down instructions, while satisfying user-specified real-time constraints.

### BACKGROUND

Power efficiency for microprocessor-based equipment is becoming increasingly important due to energy conservation issues. Also, apart from energy conservation, power efficiency is a concern for battery-operated equipment, where it is desired to minimize battery size so that the equipment can be made smaller and lightweight.

From the standpoint of microprocessor design, a number of techniques have been used to reduce power usage. These techniques can be grouped as two basic strategies. First, the microprocessor's circuitry can be designed to use less power. Second, microprocessors can be designed in a manner that permits power usage to be managed.

In the past, power management techniques have primarily focused at the system level. At the system level, various ‘power-down’ modes have been implemented, which permits parts of the system, such as a disk drive, display, or the microprocessor itself to be intermittently powered down. Recently, a whole-system view of energy issues of microprocessor-based equipment has been taken. The whole-system level approach requires analyzing the code that runs on the microprocessor. Analyzing code requires analyzing both application programs and the operating systems that run on the microprocessor.

Earlier compilers performed code optimizations with a view to reducing energy consumption but not execution time. When performing energy saving optimizations it is very important that the execution time of the code is not increased.

Therefore there is a need in the art for a technique that can compile a code to reduce energy consumption when executing the code on a processor without increasing the execution time. Also, there is a need in the art for a technique that can compile a code to reduce energy consumption when executing the code and, at the same time satisfying user-specified real-time constraints.

### SUMMARY OF THE INVENTION

The present invention provides a technique for reducing power consumption during execution of computer code including power-down instructions, while satisfying user-specified real-time constraints on a microprocessor. In one example embodiment, this is accomplished by identifying one or more potential locations in the computer code where power-down instructions can be inserted. The identified potential locations are then analyzed to select locations to insert power-down instructions based on user-specified real-time constraints to reduce power consumption without significantly increasing the execution time of the computer code.

Another aspect of the present invention is a computer-readable medium having a computer program including instructions for causing a computer to perform a method of selectively controlling power to different functional units of the computer. According to the method, the process includes inserting power-down instructions in the computer-program in selected locations based on reducing power consumption and satisfying user-specified real-time constraints. The power-down instructions inserted in the selected locations reduce the power consumption during the execution of the code while satisfying the user-specified real-time constraints.

Another aspect of the present invention is a computer-readable medium having computer-running instructions for reducing power consumption during running of a computer program, including power-down instructions, while satisfying user-specified real-time constraints on a microprocessor. According to the method, the process includes identifying one or more potential locations in the computer program where power-down instructions can be inserted. The identified potential locations are then analyzed to select locations to insert power-down instructions based on user-specified real-time constraints to reduce power consumption without significantly increasing the running time of the computer program.

Another aspect of the present invention is a computer system for reducing power consumption during execution of computer code, including power-down instructions, while satisfying user-specified real-time constraints on a microprocessor. The computer system comprises a storage device, an output device, and a processor programmed to repeatedly perform a method. The method is performed by identifying one or more potential locations in the computer code for potential insertion of power-down instructions. The identified potential locations are then analyzed to select locations to insert power-down instructions based on user-specified real-time constraints to reduce power consumption without significantly increasing the execution time of the computer code.

Other aspects of the invention will be apparent on reading the following detailed description of the invention and viewing the drawings that form a part thereof

### BRIEF DESCRIPTION OF THE DRAWINGS

FIG. 1 is a flow-chart illustrating a process of reducing power consumption during execution of computer code according to the present invention.

FIG. 2 illustrates a static analysis framework used to analyze a Direct Memory Access code according to the invention.

FIGS. 3 and 4 illustrate analyzed frameworks that need to restrict the insertion of power-down instructions.

FIG. 5 illustrates a concept of a path free from requiring devices to be turned on.

FIG. 6 illustrates a binary relationship.

FIGS. 7 and 8 illustrate concepts of line graphs.

FIG. 9 illustrates an example graphical representation of a partial order.

FIG. 10 illustrates an example of a comparability graph corresponding to the partial order graph of FIG. 9.

FIG. 11 illustrates an example of an antichain in the comparability graph of FIG. 10.

FIGS. 12 and 13 illustrate example embodiments of graphs before transformation where binary relationships hold for every pair of vertices.

FIGS. 14 and 15 illustrate transformation of problem P_{K} to P₁.

FIG. 16 illustrates concepts of k-antichain.

FIGS. 17 and 18 illustrate forming transitive closure of a graph.

FIGS. 19 and 20 illustrate the concept of an induced sub-graph. FIG. 21 illustrates an extension of an antichain.

FIG. 22 illustrates an example embodiment of implementing the algorithm of the present invention to a general sequence in computer code.

FIG. 23 is a block diagram of a suitable computing system environment for implementing embodiments of the present invention shown in FIG. 1.

### DETAILED DESCRIPTION

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is; therefore, not to be taken in a limiting sense and the scope of the present invention is defined only by the appended claims, along with the full scope of equivalents to which such claims are entitled.

The present invention provides a technique to compile computer code that can reduce power consumption during execution of the computer code, including power-down instructions on a microprocessor while satisfying user-specified real-time constraints. This is accomplished by analyzing identified potential locations where power-down instructions can be inserted and further selecting the identified potential locations to insert power-down instructions so that power consumption during execution of the code is reduced without significantly increasing the execution time of the code.

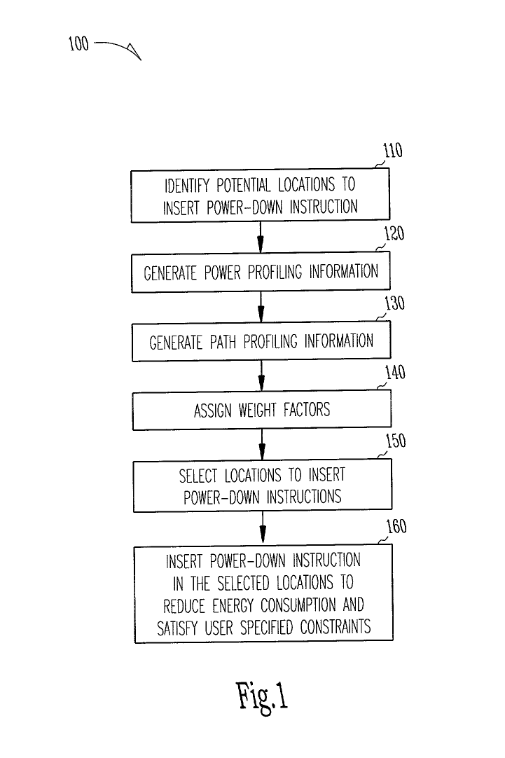

FIG. 1 is an exemplary flow-chart 100 illustrating the process of reducing power consumption according to the present invention. Flow-chart 100 includes steps 110-150, which are arranged serially in this exemplary embodiment. However, other embodiments of the invention may execute two or more blocks in parallel using multiple processors or a single processor organized as two or more virtual machines or subprocessors. Moreover, still other embodiments implement the blocks as two or more specific interconnected hardware modules with related control and data signals communicated between and through the modules, or as portions of an application-specific integrated circuit. Thus, the exemplary process flow is applicable to software, firmware, and hardware implementations.

The method of the invention can be applied to any processor, provided that its instruction set has, or is amenable to, the type of instructions described herein. The common characteristic of any processor for use with the invention is that it has more than one functional unit, whose activity can be independently controlled by instruction. In other words, an instruction may be selectively directed to a functional unit. The term ‘processor’ as used herein may include various types of micro-controllers and digital signal processors (DSPs), microprocessors, as well as general-purpose computer processors.

The term ‘functional units’ means components within the processor's central processing unit, such as separate data paths or circuits within separate data paths. Additionally, as described below, the functional units may comprise components within the processor but peripheral to its central processing unit, such as memory devices or specialized processing units.

Step 110 identifies one or more potential locations in computer code where power-down instructions can be inserted. The computer code is written for a microprocessor including distinct functional units. In some embodiments, the computer code is searched to identify potential locations in the computer code where certain functional units are not being used. In these embodiments, the determination of the functional units not being used is accomplished based on functional unit usage transfer function at each of the potential locations, as specified in standard monotone data-flow frameworks. Standard data-flow frameworks provide a theoretical basis for statically analyzing program code to derive relevant information from the code. In some cases, the usage of units can be identified from the semantics of the instructions. For example, functional units such as an adder or multiplier are directly tied to the semantics of the computer code instruction. If the instruction is an Add instruction, it can be assumed that the adder is being used in that region of the code.

In some embodiments, the potential locations are identified by scanning the code to identify segments where the functional unit is not used. A segment in the code is a consecutive sequence of instructions that can be executed in some execution instance. ‘Inactive segments’ are identified to increase efficiency. Various power-modeling techniques can be used to determine the length of time during which it is more efficient to turn a component off (or partially off) then on again versus leaving it on. The resulting ‘power down threshold’ may be different for different functional units and for different power-down levels.

After an inactive segment is identified, depending on factors such as the length of the segment, an appropriate power-down instruction is selected. For example, a long segment might call for a full power-down instruction whereas a shorter segment might call for an intermediate power down instruction. The power-down instruction is inserted at the beginning of the segment. Depending on the processor architecture, a power-up instruction may or may not be used. In some embodiments, the power-up instruction can include restoring at least one function unit to a ready state powered-down by the inserted power-down instructions. The process is repeated for each functional unit. The power down instructions can also include first and second power-down instructions. The first power-down instruction can reduce power to the entire functional unit, such that the functional unit is placed in a low state of readiness. The second power-down instruction can reduce power to only a part of the functional unit, such that the functional unit is placed in an intermediate state of readiness.

The location of ‘inactive segments’ may be done statically by analyzing processor cycles prior to executing the code. For static analysis, the compiler can estimate the number of execute cycles between start and stop points, which may include an estimation of loop cycles and other statistical predictions. Static analysis can also include analyzing processor cycles prior to executing the code to identify ‘inactive segments.’ In some embodiments, static analysis includes analyzing the text in the code for the functional units not being used prior to executing the code. The location of ‘inactive segments’ can also be done by dynamic analysis of the code in an executable form, such that the compiler may run the code and actually measure time. In either case, the compiler locates program segments of functional unit non-use.

In some embodiments, if a microprocessor has an on-chip cache, the external memory interface (EMIF) unit can be assumed to be not used at a location only if it can be shown that the memory reference (if any) of the instruction at that location is sure to cause a hit in the on-chip cache. Static analysis for cache behavior can be used to identify whether a particular memory reference can cause a hit or miss in the on-chip cache.

To further illustrate the static analysis of the present invention, one example embodiment is the usage of the direct memory access (DMA) controller as a functional unit. In this embodiment, the microprocessor is assumed to have a DMA instruction to initiate DMA transfers. DMA transfers happen between input/output (I/O) devices and memory. In this embodiment, the DMA instruction gives the number of bytes that have to be transferred between an I/O device and memory (for our analysis, the direction of transfer does not matter).

For an instruction being executed, microprocessor cycles in which the external memory bus is unused are “stolen away” by the DMA controller. In these bus-idle cycles when the microprocessor executes internal operations (an arithmetic logic unit (ALU) operation, for instance), the DMA controller grabs the bus and uses it for DMA transfer. Whenever an instruction enters a cycle in which there is a need for the bus, it is assumed that the DMA controller releases the bus for use by the microprocessor. In this embodiment, the time required to do DMA transfer of a fixed number of bytes is known. The period of a processor cycle is also known. Hence, for the purpose of our analysis, the existence of a function f is assumed, which maps each instruction to the number of bytes that can potentially be transferred during that instruction using a DMA operation.

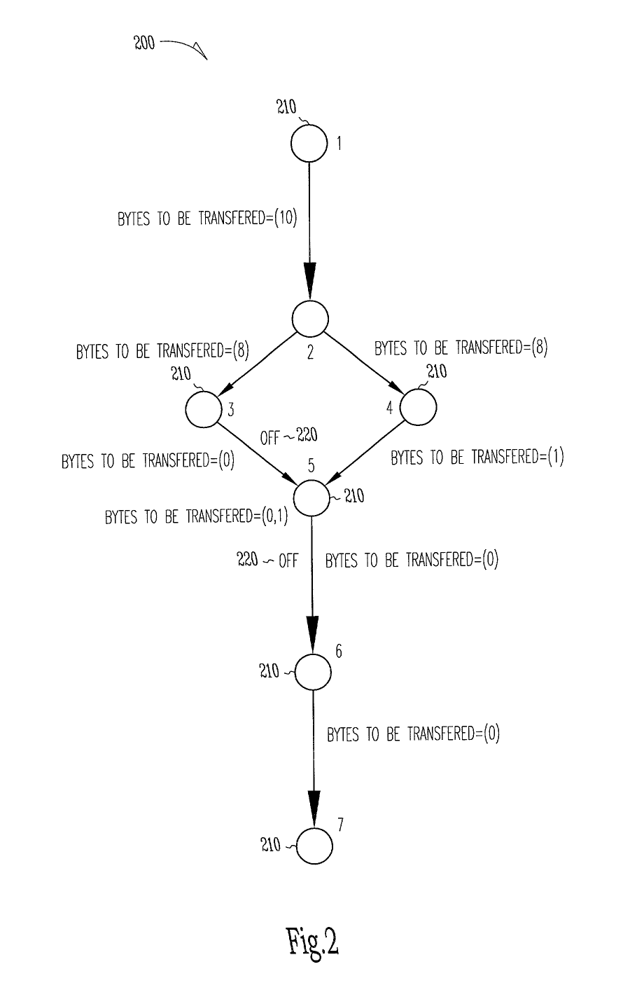

Since static analysis assumes a control flow graph (CFG) representation of the program being analyzed, the computer code is converted into a CFG with nodes representing instructions and the edges representing the flow of control between the instructions. Two external nodes are assumed for the CFG, a START node, which is a node without any predecessor and an END node, which is a node without any successor. FIG. 2 illustrates a CFG representation 200 of the DMA analysis framework. In this example embodiment, a single functional unit (U) that can be powered down is used to simplify the CFG representation. Assuming I as the set of instructions provided by the computer/processor that can appear in the code, and since each of the instructions has a finite length that will change from processor to processor, the instructions cannot be listed down. Further assume an upper bound parameter B as the maximum number of bytes that can be specified in one DMA transfer instruction. This parameter can also change from processor to processor. Therefore, we can only assume B to be of a finite large value and that during any execution of the program, all bytes initiated for transfer through one DMA instruction are transferred before a second DMA instruction is initiated. Without this assumption, it is possible that the static analysis lattice may not have an upper bound.

In this embodiment, the functionf exists as f: I→{0}∪Z⁺ which is the set of positive integers. This function gives, for an instruction, the number of bytes that can potentially be transferred through DMA during the execution of that instruction.

For an instruction, i∈I that has no bus-idle cycle, f (i)=0. Also, for a DMA instruction i, f (i)=0.

In this embodiment, there is also a second function g: I→{0}∪Z⁺. This function gives, for an instruction, the number of bytes of DMA transfer that are initiated by that instruction. For all instructions other than the DMA instruction, the value of this function is zero.

Let S be the set of integers from 0 to B.

In this embodiment, the static analysis framework is defined as follows:

Set of lattice elements=P(S).

The partial order relation is set inclusion.

External value =0.

Join operator u (set union).

Transfer function for a given instruction i (a node in the CFG representation of the program) is given by: δᵢ: P(S)→P(S) and is defined using the equation as:

δᵢ(S′)={[s−f(i)+g(i)]|s∈S′}

where [x] is defined as:

[x]=x if x≧0

=0 otherwise

wherein δᵢ is a monotonic and distributive function. Also, the lattice is finite and satisfies the ascending chain condition. Hence, the standard iterative fixed-point computation algorithm terminates, computes the maximal-fixed-point (MFP) solution and, sinceδᵢ is distributive, the MFP solution is the same as the meet-over-paths (MOP) solution.

At the end of the fixed-point computation, the exit of each CFG node 210 is annotated with a set of all possible values of the number of bytes that remain to be transferred through DMA at that node 210. Node n, is this set is denoted by node_info(n). Numbers 1, 2, . . . 7 shown next to nodes 210 represent a naming scheme for nodes 210. Arrows 230 between nodes depict controlled flow between the nodes 210.

Since power-down instructions are placed on the edges, DMA usage information is associated with edges rather than nodes. For an edge e=(n₁, n₂) edge_info(e)=1 if the DMA controller can be switched off at e, otherwise edge_info(e)=0. If edge info(e)=1, there are no bytes that remain to be transferred at node n₂, if control reaches n₂ through e. Then,

edge_info(e) 1 if node_info(n₁) and δ_{i n2} (node info(n₁)) are both singleton sets containing zero.

edge_info(e)=0, Otherwise where iₙ is the instruction associated with a node n in the CFG.

If edge_info(e)=1, then e is a candidate edge for placing the power-down instruction that powers down the DMA controller. Such an edge e is called an OFF edge 220.

FIG. 2 illustrates the identification of OFF edges 220 in a CFG for the DMA analysis framework 200. The above-described technique is based on a static analysis technique described in detail in F. Nielson, H. R. Nielson and C. Hankin: Principles of Program Analysis, Springer, 1999.

Step 120 generates power-profiling information associated with each of the identified potential locations or inactive segments. Step 130 includes generating path-profiling information associated with each of the identified potential locations by executing the computer code. After completing the static analysis, energy profilers perform detailed energy profiling of the computer code on energy models of the microprocessor. Energy profiling will associate with each of the identified potential locations (OFF edge) and will predict the energy savings that can be obtained if the functional unit U is switched off at that OFF edge.

Step 140 assigns weight factors to each of the identified potential locations based on the generated power-profiling information and the path-profiling information. In some embodiments assigning weight factors to each identified potential location includes extracting potential energy savings for each identified location using the generated power profile analysis information. The extracted potential energy savings is used to assign weight factors to each identified potential locations. In some embodiments, the generated path-profiling information further includes generating execution probability for each identified potential location.

In some embodiments, the potential (expected) energy savings E(e) associated with each of identified potential locations (OFF edges 220) e is expressed using the equation:

E(e)=p₁×Eₙ₁ +p₂×Eₙ₂+ . . . +pₗ×Eₙₗ

wherein P₁, P₂, . . . pₗ are the probabilities of execution of the l paths from START to END on which e is present, Eₙᵢ's (1≦i≦l) are the energy savings that are associated with each path. Eₙᵢ is calculated by considering the largest prefix, starting at edge e, of a path with probability pᵢ which has only OFF edges 220. The execution probabilities are then obtained from an execution profiler. The topic of energy profiling is described in detail in T. Simunic, L. Benini and G. De Micheli: Cycle-Accurate Simulation of Energy Consumption in Embedded Systems, Design Automation Conference, 1999. It is also further discussed in V. Tiwari, S. Malik, A. Wolfe and M. T-C. Lee: Instruction Level Power Analysis and Optimization of Software in Technologies for Wireless Computing, ed. A. P. Chandrakasan and R. W. Broderson, Kluwer Academic Publishers, 1996.

In some embodiments, assigning the weight factor includes executing the code to assign a first weight factor based on the extracted potential energy savings to each of the identified potential locations. Further, the code is executed to assign a second weight factor based on execution probability at each of the identified potential locations. Then the weight factor for each of the identified potential locations is calculated based on computing product of the first and second weight factors. The calculated weight factor is then assigned to each identified potential location.

Step 150 includes selecting locations to insert power-down instructions from the identified potential locations in the code based on reducing energy consumption and satisfying user-specified real-time constraints. The user-specified real-time constraints can include constraints such as the number of power down instructions that can be inserted in an execution path, the number of additional cycles of execution time the user is willing to incur, and other such constraints.

In some embodiments, selecting identified potential locations based on reducing energy consumption and satisfying user-specified real-time constraints is performed as follows:

Assume that inserting power-down instructions on the selected potential locations of OFF edges increases the execution time of a path from the START node to the END node beyond a value Δ cycles.

The value Δ cycles is a user-specified real-time constraint imposed on the computer code. If the execution time of each power-down instruction is T cycles, then the above constraint can be referred to as the execution time constraint and defined as follows.

Execution time constraint: Idle instructions are inserted on a subset of OFF edges such that on no execution path from the START node to the END node, there are more than K=[Δ/T] power-down instructions.

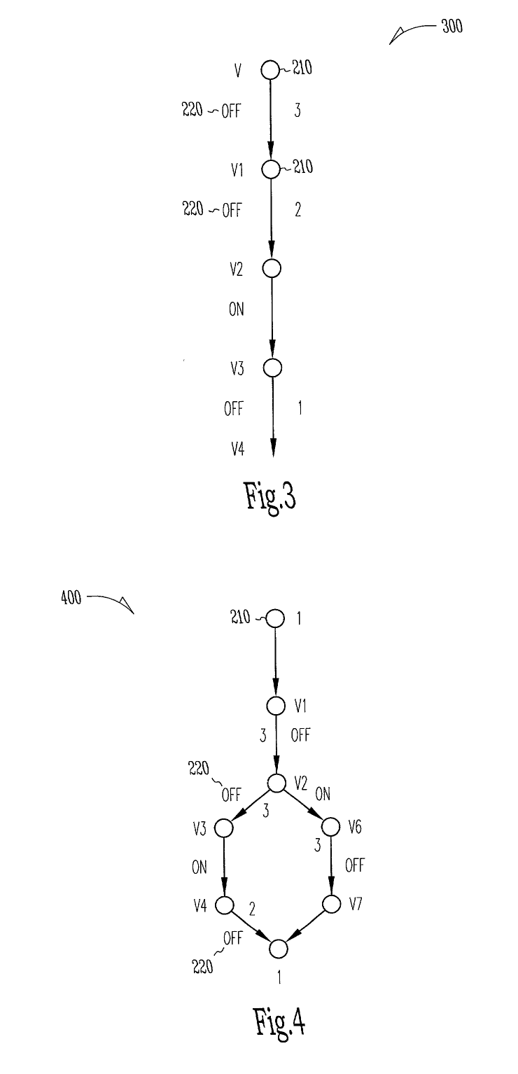

However, other restrictions on choosing a set of edges to put power-down instructions can exist. According to one embodiment of the present invention, user-instruction can include prohibiting executing two power-down instructions unless the device is turned ON between them. This situation is illustrated in FIGS. 3 and 4, including example embodiments of CFG's 300 and 400 generated after performing static analysis of computer codes.

An ON-free path from node n₁ to node n₂ is a path that consists entirely of OFF edges.

FIG. 5 illustrates the concept of an ON-free path using the example embodiment of CFG 500.

According to one embodiment of the invention, the selection of edges to insert power-down instructions is done in such a way that the method does not choose any two edges such that all paths between them are ON-free. This embodiment can be represented as F1. According to an alternative embodiment, the selection of edges is done in such a way that the method does not choose any two edges such that there is an ON-free path between them. This embodiment can be represented as F2.

Given CFG G=(V, E), with annotation OFF on some of its edges, a binary relation OFF_{G} on E, edges of this CFG are defined. According to one embodiment of the invention, for condition F1, OFF_{G} (e₁, e₂) if and only if all paths between e₁ and e₂ are ON-free. According to the alternative embodiment, for condition F2, if and only if there is a path between e₁ and e₂ which is ON-free.

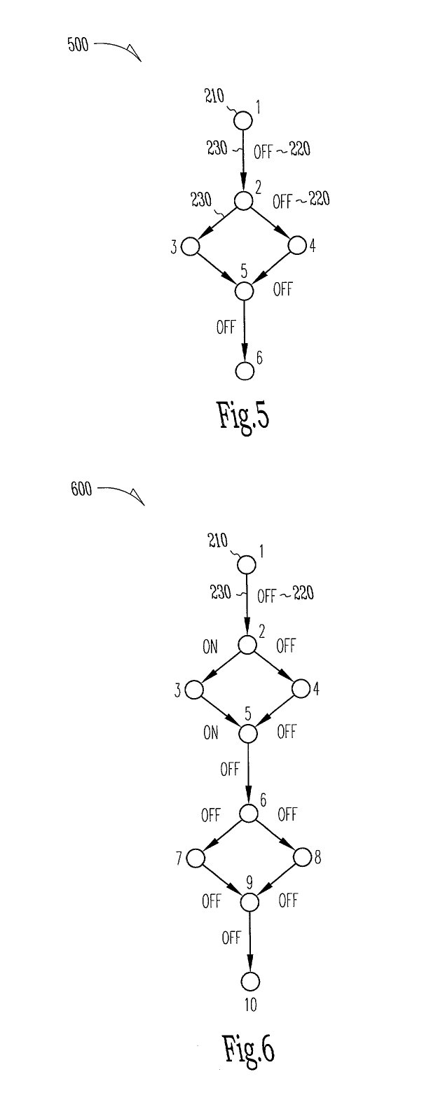

FIG. 6 illustrates the definition of the OFF_{G} relation using a CFG 600.

A standard static analysis framework for reachability may be used to compute the OFF_{G} relation.

From the discussion above, it follows that power-down instructions should be inserted on the edges such that they are an independent set in the OFF_{G} graph. That is, two edges containing power-down instructions should not be connected by the OFF_{G} relation computed above. In this embodiment, the choice of choosing F1 or F2 will be implicit in computing OFF_{G}. The techniques are independent of the computation of OFF_{G}.

In this embodiment, the problem may be stated as follows:

Input: A CFG, G=(V, E), with some edges marked OFF, a weight function W: E →R⁺ and a number k.

Valid solution: E′ [symbol] E, where E′ is an independent set with respect to relation OFF_{G} and the execution time constraint is satisfied.

Objective:

$$O bj e c t i v e : m a x i m i z e {\sum }_{e ∈ {E}^{′}} W ( e )$$

According to one embodiment, the CFG is taken to be directed acyclic graph (DAG). The execution time constraint is simplified by the absence of loops.

In this embodiment, a directed acyclic graph (DAG), G=(V, E), a weight function W: E→R⁺, and two special nodes START, END∈V are used.

START has indegree 0 and END has outdegree 0. Some edges of the graph are marked OFF. OFF may be considered to be a function OFF: E→{0, 1}

In this embodiment, weights W can be represented by l bit numbers, where l is the size of the graph (number of nodes plus edges in G). This allows us to omit the size of weights in the size of the input. Further, it avoids degenerate cases, based on the assumption throughout that all nodes in G are on some path from START to END.

In this embodiment, problem P′ is defined as follows.

Input instance: G=(V, E), W, OFF, k∈N, as described above.

Valid solution: A set E′ [symbol] E such that on any path from START to END in G, there are no more than k edges in E′ and, for all e₁, e₂ ∈E′, ┐OFF_{G} (e₁, e₂)

In this embodiment, W (E′) is maximized by formulating where the nodes are weighted and play the same role as edges in the above formulation. This is done easily using the well-known notion of a line graph of a given graph.

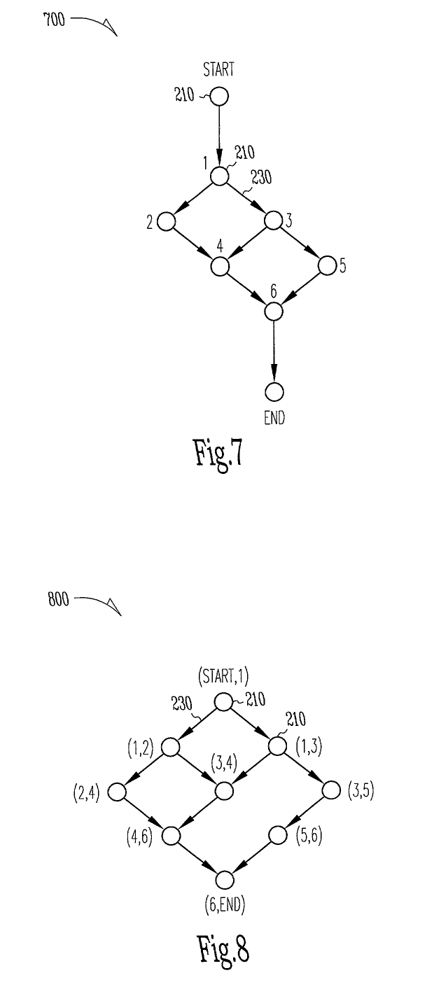

FIGS. 7 and 8 illustrate the definition of a line graph of a graph using CFG's 700 and 800. For a graph G, L(G) denotes its line graph. An edge path in G corresponds to a vertex path in L(G) and vice-versa. If G is acyclic then L (G) is also acyclic.

From G as above, a node weighted graph instance L (G) is obtained as follows. The problem P′ when reflected on L (G) becomes the problem P defined below.

Input instance: G=(V,E), W, OFF, k∈N, where W: V→R⁺,

OFF: V→{0, 1}

Valid solution: A set V′ ∈V such that on any path from START to END in G there are no more than k nodes in V′, and for all v₁, v₂ ∈V′, ┐OFF_{G} (v₁, v₂).

In this embodiment, W (V′) is maximized by computing OFF_{G} on vertices similarly as described for the OFF_{G} computation on edges except that now OFF marking in a path are on nodes instead of on edges.

For each fixed k∈N, a problem Pₖ is defined by fixing the parameter k in P.

A valid solution of P′ on G yields a valid solution of the same weight of P on L(G) and vice-versa. These solutions are related by identification of edges in G with vertices in

L(G) as in the construction of L(G). In this embodiment, it follows that the optimal value for P′ on G is the same as the optimal value for P on L(G).

From now on, the node centric view is adopted and attention is restricted to problem P (and some variants of it).

P₁ is solvable in polynomial time.

P₁ is tantamount to solving the following problem: given a weighted (strict) partial order, find the maximum weight antichain in it. Undirected graphs obtained by erasing directions in some partial order are known as comparability graphs in the literature. The maximum weight antichain problem is the same as finding the maximum weight independent set in comparability graphs. The latter problem is known to be solvable in polynomial time using network flow techniques.

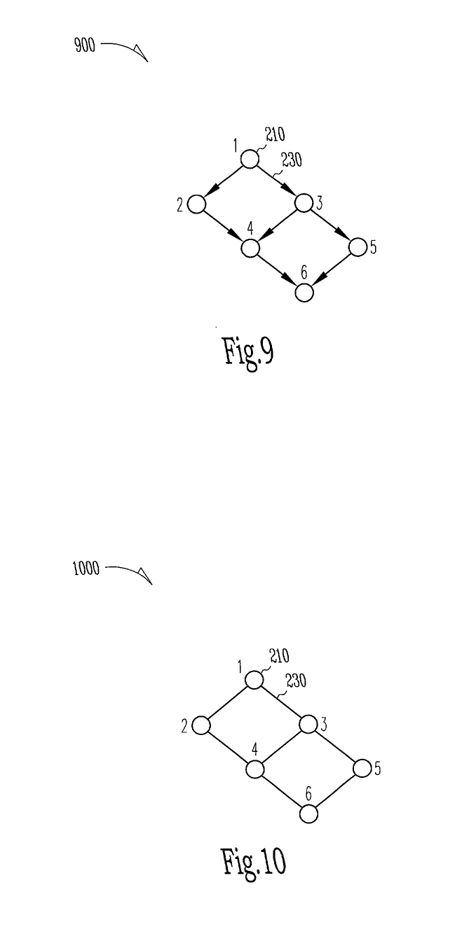

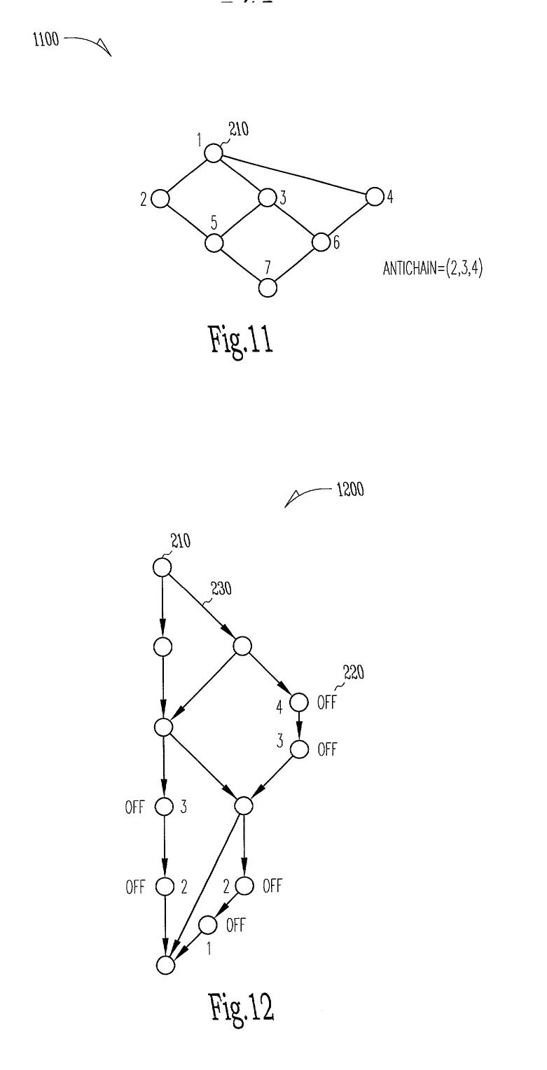

FIG. 9 illustrates a partial order graph 900. Partial order in a graph refers to the ordering of the nodes. The ordering is partial when some of the nodes are not ordered between themselves. For example, in FIG. 9, one ordering of nodes (shown by directed lines also know as directed edges) present in the graph is 1,3,5,6 and another ordering is 1,2,4,6 but there does not exist any ordering between nodes 2 and 3 as there is no directed edge connecting them. As described before, comparability graph 1000 shown in FIG. 10 is a partial ordering on the graph without directions (arrows). As an example, the comparability graph of FIG. 9 is shown in FIG. 10. The antichain in the comparability graph 1000 is a set of nodes without any ordering between any pair of nodes. As shown in FIG. 11, a set of nodes {2,3,4} is hence an antichain.

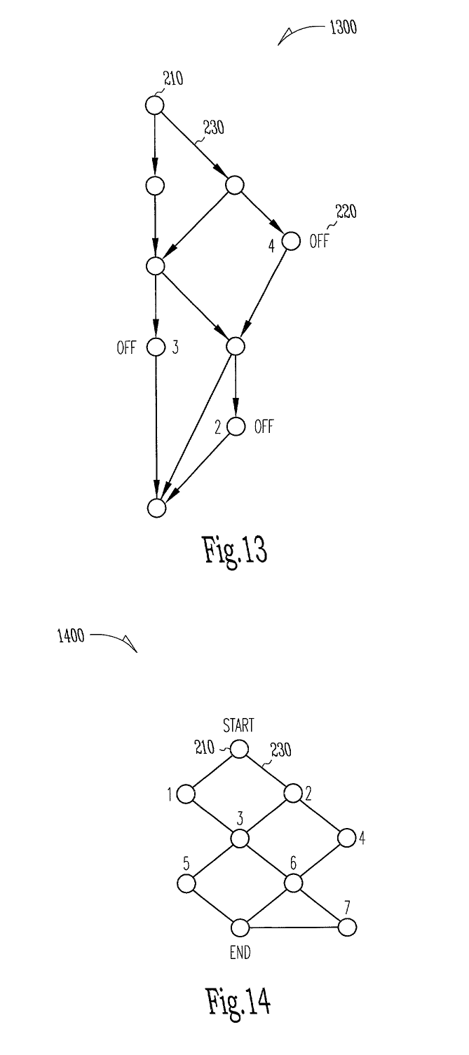

FIGS. 12 and 13 illustrate the case of flow graphs 1200 and 1300 where there is no branching between any power-off to corresponding power-on switching. A simple transformation in this case will result in an equivalent graph of the type where for every V₁, V₂ ∈V(G), ┐OFF_{G} (v₁, v₂).

FIG. 12 shows a graph that can be transformed to the graph of FIG. 13, which meets this situation.

In this embodiment, a method which solves the special case of P where for every V₁, V₂ ∈V(G), ┐OFF (v₁, v₂ is defined as follows:

A polynomial time reduction from P to P₁ is used, for the special case discussed above. In this embodiment, the input graph is assumed to be a strict partial order as the relation

OFF_{G} is not required to be computed from the original graph G.

Given an instance I=<G(V, E), W, k> of P, a new instance is created as follows:

I′=<G′(V′, E′), W′> of P₁ as follows.

V′={1, 2, . . . ,k}×V,

E′((I,v₁),(J,v₂)) if [(I≦J) [symbol] E(V₁,V₂)] [symbol] [(I<J) [symbol] (V₁=V₂)]

W′((I, v))=W(v)

If G is a strict partial order then G′ is also a strict partial order.

In this embodiment, the algorithm described above for P₁ can be run on G′ to get the solution for Pₖ.

The proof of the optimality preservation of this transformation can be obtained using A. Seth, R. B. Keskar, and R. Venugopal: Algorithms for Energy Optimization Using Processor Instructions, Technical Report No: TR-CSRD-04-2001-01, Saken Communication Technologies Limited, Bangalore, India.

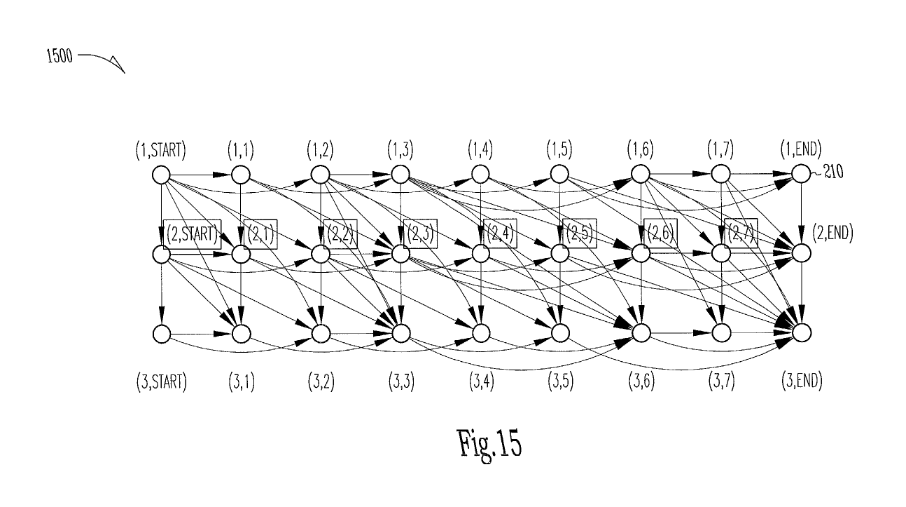

FIGS. 14 and 15 illustrate the transformation of graph G 1400 to G′ 1500 for k =3. The example illustrated in FIGS. 14 and 15 can be formulated as below:

Input instance: A directed acyclic graph G=(V, E), W, OFF, k∈N, where W: V→R⁺, OFF:E→{0, 1}

Valid solution: A set V′ [symbol] V such that on any path from START to END in G there are no more than k nodes in V′ and for all v₁, v₂∈V (G), ┐OFF_{G} (v₁, v₂)

In this embodiment, W (V′) is maximized by assuming OFF_{G} is transitive, so this solution corresponds to the case using condition F2 for computing OFF_{G}. CFG 1400 shown in FIG. 14 is transformed to the graph 1500 shown in FIG. 15 according to the transformation described with reference to FIGS. 12 and 13.

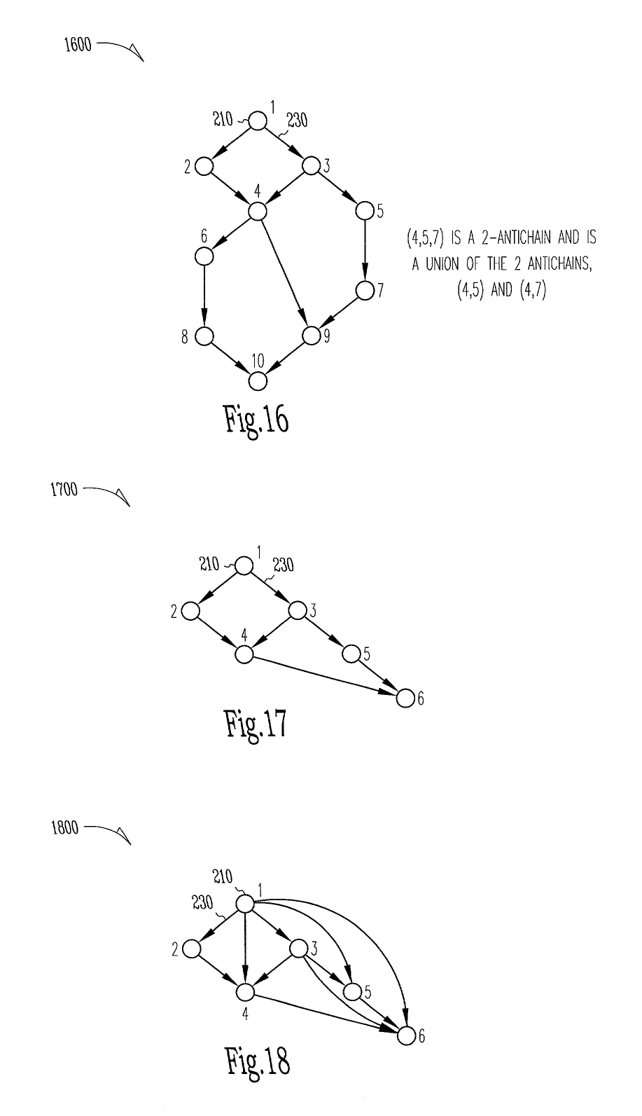

FIG. 16 illustrates the concept of a k-antichain 1600. K-antichain means a set of nodes in partially ordered graph such that it is union of at most k antichains in a graph. For example, in FIG. 14, (4,5,7) is said to be 2-antichain (k=2) as it is the union of two antichains {4,5} and {4,7}. The word ‘antichain’ has been described in detail with reference to FIGS. 9,10, and 11.

FIGS. 17 and 18 illustrate transitive closures of a graph. As shown in FIG. 18, graph 1800 is the transitive closure of graph 1700 shown in FIG. 17. The term ‘transitive closure’ is explained below:

a) if there exists an edge between nodes ‘a’ and ‘b’, then we denote it by (a,b).

b) A path in a graph G(V, E) is an alternating sequence of nodes and edges say v_{—}0, x_{—}1, v_{—}1, . . . , x_n, v_n where each x_i is an edge (v_i-1, v_i) ∈ E and each v_i ∈ V and each v_i is distinct.

c) Then,

A graph G′(V′, E′) is said to be a transitive closure of graph G(V, E),

If and only if

i) V′=V {i.e. same set of nodes in both G and G′}

ii) E′ is constructed as follows

If node a∈V′ and node b E V′, then (a, b)∈E′ if and only if there exist a path of length greater than or equal to 1 from node a to node b in graph G.

The above definition is illustrated in FIG. 18 where graph 1800 is the transitive closure of the graph 1700 shown in FIG. 17.

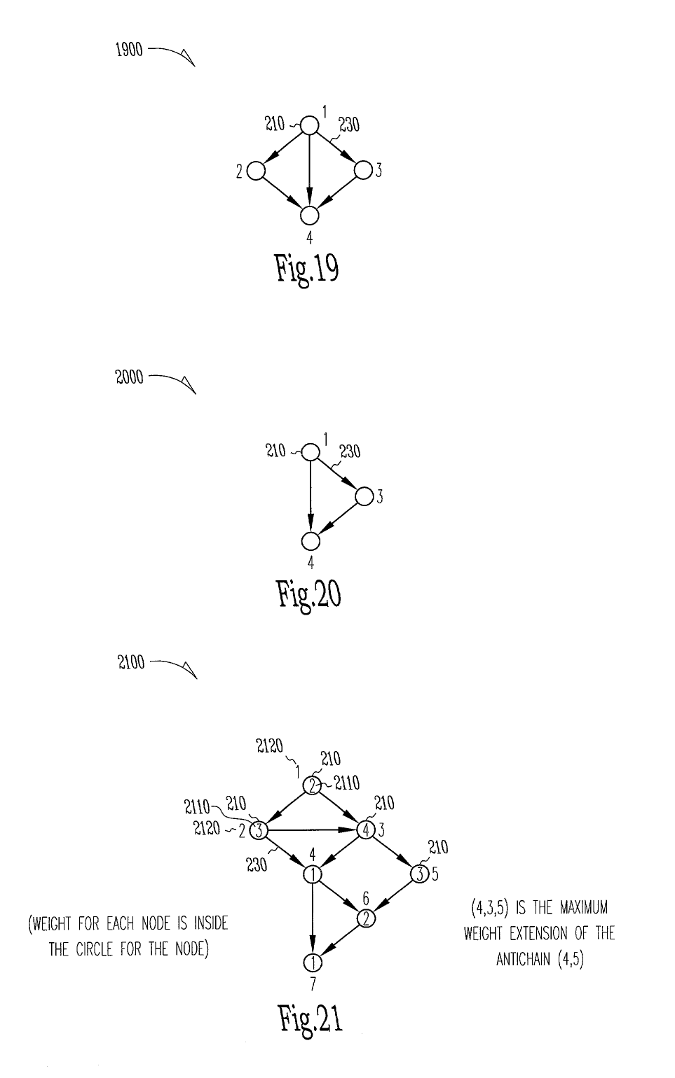

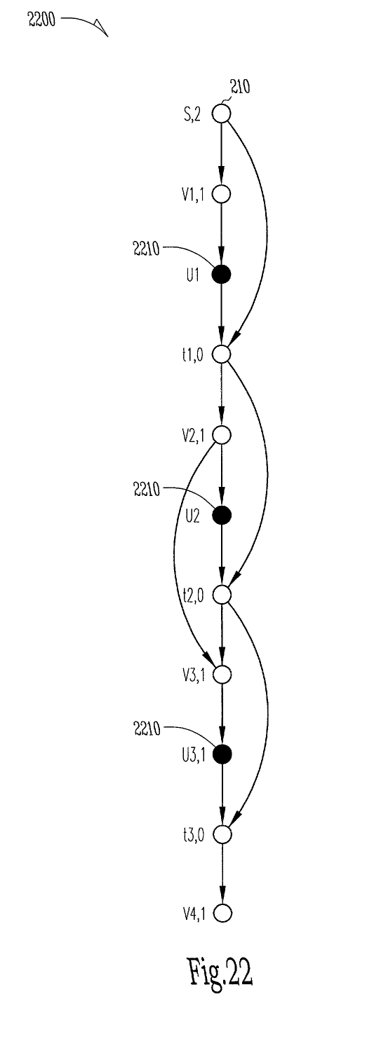

FIGS. 19 and 20 illustrate an example of a sub-graph formation. Graph 2000 shown in FIG. 20 is a sub-graph of graph 1900 shown in FIG. 19 induced by the set of vertices {1,3,4} shown in the graph 1900. A graph G′ is said to be a sub-graph of G′ induced by a set of vertices V, if and only if G′ contains only a set of V vertices and all the edges between nodes in V are also edges in G.

A graph G′(V′, E′) is said to be a sub-graph of graph G(V, E) induced by set of vertices V″ [symbol] V, if and only if

i) V′=V″

ii) If node a∈V′ and node b∈V′ then

(a, b)∈E′, if and only if (a, b)∈E

Input: A DAG G=(V, E), W, OFF, k∈N, where W: V→R⁺,

OFF: E→{0, 1}

Compute OFF_{G} using condition F2;

H:=Transitive closure of G;

/* H is a strict partial order and OFF_{G} is a sub-partial order of H*/

I_{0= ; I:=} [symbol]0;

H₁:=H;

do

I+1;

Find a maximum weight k-antichain J_{I}, extending I_{I-1}, in (H_{I}, E(H));

Find a maximum weight antichain I_{I} extending I_{I-1}, in (J_{I}, E(OFF_{G}));

/* E(H) is the set of edges in the transitive closure of G. E(OFF_{G}) is the set of edges in partial order OFF_{G}.*/

H_{I+1}=sub-graph of H_{I} induced on V (H_{I})−(J_{I}-I_{I})

While I_{I}≠I_{I-1};

Output: I_{I}

FIG. 21 illustrates an example embodiment of FIG. 20. Numbers 2110 shown inside the circle represent weights associated with nodes 210. Whereas numbers 2120 shown outside nodes 210 represent the numbering scheme for the nodes 210 as described with reference to FIG. 2. Nodes 210 with reference numbers 4 and 5 form an antichain (1-antichain). We extend this 1-antichain to a 2-antichain using the algorithm described above such that the sum of weights of nodes 210 in this 2-antichain is the maximum among all 2-antichains involving nodes 210 with nodes numbered 4 and 5. Using the above-described algorithm, a 2-antichain with nodes numbered as {4,3,5} is obtained such that the sum of weights of these nodes (1+4+3=8) is the maximum among all of the 2-antichains involving nodes labeled 4 and 5.

FIG. 22 illustrates an example embodiment of implementing the algorithm of the present invention to a general case. In FIG. 22, every node 210 has two elements written to next to it. The first element refers to the label of the node. For example, s, v1, u1 and so on refers to node labels. Here, labels are used instead of numbers to avoid confusion, as the second element is a number referring to the weight associated with a node. Filled nodes 2210 refer to nodes U1, U2, and U3 where power-down instructions cannot be inserted. Unfilled nodes 210 refer to nodes where power-down instructions can be inserted, and hence can be referred to as OFF nodes, as shown in FIG. 12. Referring now to FIG. 21, to find a 3-antichain such that the sum of weights is maximum: applying the algorithm for the general case shown in FIG. 22 gives the answer nodes {v1, v2, v4} for which the sum of weights is optimal. This is for one execution sequence of the above-mentioned algorithm that starts with J1={s, v1, v2}. It is also possible that another execution sequence of the algorithm may give a sub-optimal answer. Hence, the above algorithm is an approximate algorithm for the general case shown in FIG. 22.

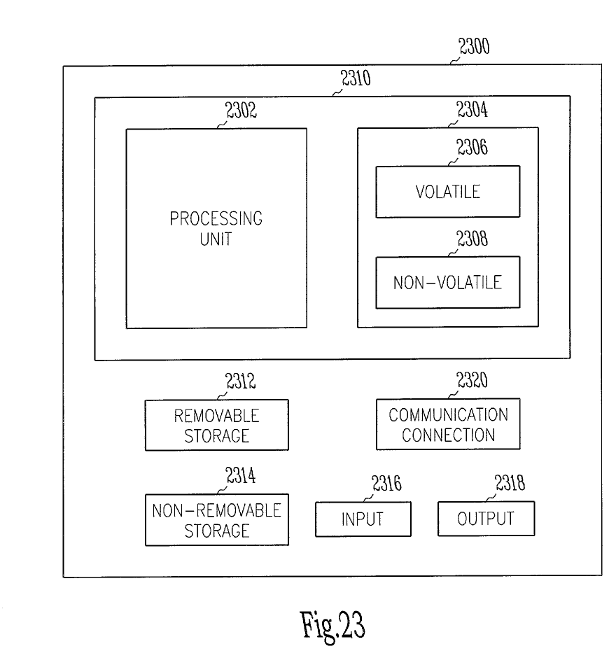

FIG. 23 shows an example of a suitable computing system environment 2300 for implementing embodiments of the present invention, such as those shown in FIG. 1. Various aspects of the present invention are implemented in software, which may be run in the environment shown in FIG. 23 or any other suitable computing environment. The present invention is operable in a number of other general purpose or special purpose computing environments. Some computing environments are personal computers, server computers, hand-held devices, laptop devices, multiprocessors, microprocessors, set top boxes, programmable consumer electronics, network PCs, minicomputers, mainframe computers, distributed computing environments, and the like. The present invention may be implemented in part or in whole as computer-executable instructions, such as program modules that are executed by a computer. Generally, program modules include routines, programs, objects, components, data structures and the like to perform particular tasks or to implement particular abstract data types. In a distributed computing environment, program modules may be located in local or remote storage devices.

FIG. 23 shows a general computing device in the form of a computer 2310, which may include a processing unit 2302, memory 2304, removable storage 2312, and non-removable storage 2314. The memory 2304 may include volatile memory 2306 and non-volatile memory 2308. Computer 2310 may include—or have access to a computing environment that includes—a variety of computer-readable media, such as volatile memory 2306 and non-volatile memory 2308, removable storage 2312 and non-removable storage 2314. Computer-readable media also include carrier waves, which are used to transmit executable code between different devices by means of any type of network. Computer storage includes RAM, ROM, EPROM & EEPROM, flash memory or other memory technologies, CD ROM, Digital Versatile Disks (DVD) or other optical disk storage, magnetic cassettes, magnetic tape, magnetic disk storage or other magnetic storage devices, or any other medium capable of storing computer-readable instructions. Computer 2310 may include or have access to a computing environment that includes input 2316, output 2318, and a communication connection 2320. The computer may operate in a networked environment using a communication connection to connect to one or more remote computers. The remote computer may include a personal computer, server, router, network PC, a peer device or other common network node, or the like. The communication connection may include a Local Area Network (LAN), a Wide Area Network (WAN) or other networks.

### Conclusion

The above-described invention provides a technique for compiling a code to reduce energy consumption when executing the code on a processor without increasing the execution time while satisfying user-specified real-time constraints.

The above description is intended to be illustrative, and not restrictive. Many other embodiments will be apparent to those skilled in the art. The scope of the invention should therefore be determined by the appended claims, along with the full scope of equivalents to which such claims are entitled.

What is claimed is:

1. A method of compiling computer code including power-down instructions to reduce power consumption during execution of the code while satisfying user-specified real-time constraints on a microprocessor, comprising:
identifying one or more potential locations in the computer code where the power-down instructions can be inserted;
selecting locations to insert the power-down instructions from the identified potential locations in the code based on reducing power consumption and satisfying user-specified real-time constraints; and
inserting the power-down instructions in the selected locations to reduce the power consumption during the execution of the code while satisfying user-specified real-time constraints.

2. The method of claim 1, wherein the code is written for a microprocessor having distinct functional units.

3. The method of claim 2, wherein identifying potential locations comprises:
identifying potential locations based on the functional units not being used in the potential locations, wherein the functional units not being used are determined based on functional unit usage transfer functions at each of the potential locations as specified in standard monotone data-flow frameworks.

4. The method of claim 3, wherein identifying potential locations is accomplished by statically analyzing processor cycles prior to executing the code.

5. The method of claim 4, wherein statically analyzing processor cycles is accomplished by statically analyzing the text in the code for the functional units not being used prior to executing the code.

6. The method of claim 3, wherein each of the power-down instructions comprise:
a first power-down instruction operable to reduce power to all of the at least one functional unit, such that the functional unit is placed in a low state of readiness and a second power-down instruction operable to reduce power to only a part of the at least one functional unit, such that the functional unit is placed in an intermediate state of readiness.

7. The method of claim 1, wherein selecting identified potential locations on the computer code based on satisfying the user-specified real-time constraints, comprise:
executing the code to generate power-profiling information associated with each of the identified potential locations;
executing the code to generate execution path-profiling information associated with each of the identified potential locations;
assigning a weight factor to each of the identified potential locations based on the generated power-profiling and path-profiling information; and
selecting the locations to insert the power-down instruction from the identified locations based on the assigned weight factors and the user-specified real-time constraints.

8. The method of claim 7, wherein executing the code to generate path-profiling information to each of the identified potential locations further comprises:
generating execution probability of each of the identified potential locations based on the generated path-profiling information.

9. The method of claim 8, wherein assigning the weight factor comprises:
extracting potential energy savings for each of the identified potential locations using the generated power profile analysis information; and
assigning the weight factor to each of the identified potential locations based on the extracted potential energy savings and the generated execution probability.

10. The method of claim 9, wherein assigning the weight factor further comprises:
executing the code to assign a first weight factor based on the extracted potential energy savings to each of the identified potential locations;
executing the code to assign a second weight factor based on execution probability at each of the identified potential locations;
computing a product of the first and second weight factors for each of the identified potential locations;
calculating the weight factor for each of the identified potential locations based on the computed product of the first and second weight factors; and
assigning the calculated weight factor to each of the identified potential locations.

11. The method of claim 1, wherein user-specified real-time constraints comprise:
the number of power-down instructions that can be inserted in an execution path, including one or more identified potential locations.

12. The method of claim 11, wherein user-specified real-time constraints comprise:
the number of additional cycles of execution time the user is willing to incur due to an insertion of the power-down instruction at each of the identified potential locations.

13. The method of claim 11, further comprising:
inserting power-up instruction in the code to restore at least one functional unit to a ready state powered-down by the inserted power-down instructions.

14. A computer-readable medium having computer-executable instructions for reducing power consumption while running a computer program, comprising:
identifying one or more potential locations in the computer program where power-down instructions can be inserted;
selecting locations to insert the power-down instructions from the identified potential locations in the program based on satisfying user-specified real-time constraints; and
inserting the power-down instructions in the selected locations to reduce power consumption while running the computer program while satisfying the user-specified real-time constraints.

15. The medium of claim 14, wherein the code is written for a microprocessor including distinct functional units.

16. The medium of claim 14, wherein identifying potential locations comprises:
identifying the potential locations based on the functional units not being used in the potential locations, wherein the functional units not being used are determined based on functional unit usage transfer functions at each of the potential locations as specified in standard monotone data-flow frameworks.

17. The medium of claim 16, wherein identifying potential locations is accomplished by statically analyzing processor cycles prior to running the program.

18. The medium of claim 14, wherein selecting the identified potential locations on the computer program based on satisfying the user-specified real-time constraints, comprise:
running the computer program to generate power-profiling information associated with each of the identified potential locations;
running the computer program to generate execution path-profiling information associated with each of the identified potential locations;
assigning a weight factor to each of the identified potential locations based on the generated power-profiling and path-profiling information; and
selecting the locations to insert the power-down instructions from the identified locations based on the assigned weight factors and the user-specified real-time constraints.

19. The medium of claim 18, wherein running the program to generate path-profiling information to each of the identified potential locations further comprises:
generating running probability of each of the identified potential locations based on the generated path-profiling information.

20. The medium of claim 19, wherein assigning the weight factor comprises:
extracting potential energy savings for each of the identified potential locations using the generated power profile analysis information; and
assigning the weight factor to each of the identified potential locations based on the extracted potential energy savings and the generated running probability.

21. The medium of claim 20, wherein assigning the weight factor further comprises:
running the program to assign a first weight factor based on the extracted potential energy savings to each of the identified potential locations;
running the program to assign a second weight factor based on execution probability at each of the identified potential locations;
computing a product of the first and second weight factors for each of the identified potential locations;
calculating the weight factor for each of the identified potential locations based on the computed product of the first and second weight factors; and
assigning the calculated weight factor to each of the identified potential locations.

22. The medium of claim 14, wherein user-specified real-time constraints comprise:
the number of power-down instructions that can be inserted in a running path including one or more identified potential locations.

23. The medium of claim 22, further comprising:
inserting power-up instructions in the program to restore at least one functional unit to a ready state powered-down by the inserted power-down instructions.

24. A computer system for reducing power consumption during execution of computer code, comprising:
a storage device;
an output device; and
a processor programmed to repeatedly perform a method, comprising:
identifying one or more potential locations in the computer code where power-down instructions can be inserted;
selecting locations to insert the power-down instructions from the identified potential locations in the code based on satisfying user-specified real-time constraints; and
inserting the power-down instructions in the selected locations to reduce power consumption during the execution of the code while satisfying the user-specified real-time constraints.

25. The system of claim 24, wherein the code is written for a microprocessor including distinct functional units.

26. The system of claim 24, wherein identifying the potential locations comprises:
identifying the potential locations based on the functional units not being used in the potential locations, wherein the functional units not being used are determined based on functional unit usage transfer functions at each of the potential locations as specified in standard monotone data-flow frameworks.

27. The system of claim 26, wherein identifying the potential locations is accomplished by statically analyzing processor cycles prior to executing the code.

28. The system of claim 24, wherein selecting the identified potential locations on the computer code based on satisfying the user-specified real-time constraints, comprises:
executing the code to generate power-profiling information associated with each of the identified potential locations;
executing the code to generate execution path-profiling information associated with each of the identified potential locations;
assigning a weight factor to each of the identified potential locations based on the generated power-profiling and path-profiling information; and
selecting the locations to insert the power-down instruction from the identified locations based on the assigned weight factors and the user-specified real-time constraints.

29. The system of claim 28, wherein executing the code to generate path-profiling information to each of the identified potential locations further comprises:
generating execution probability of each of the identified potential locations based on the generated path-profiling information.

30. The system of claim 29, wherein assigning the weight factor comprises:
extracting potential energy savings for each of the identified potential locations using the generated power profile analysis information; and
assigning the weight factor to each of the identified potential locations based on the extracted potential energy savings and the generated execution probability.

31. The system of claim 30, wherein assigning the weight factor further comprises:
executing the code to assign a first weight factor based on the extracted potential energy savings to each of the identified potential locations;
executing the code to assign a second weight factor based on execution probability to each of the identified potential locations;
computing a product of the first and second weight factors for each of the identified potential locations;
calculating the weight factor for each of the identified potential locations based on the computed product of the first and second weight factors; and
assigning the calculated weight factor to each of the identified potential locations.

32. The system of claim 24, wherein user-specified real-time constraints comprise:
the number of power-down instructions that can be inserted in an execution path including one or more identified potential locations.

33. The system of claim 32, further comprising:
inserting power-up instructions in the code to restore at least one functional unit to a ready state powered-down by the inserted power-down instructions.

34. A computer-readable medium having a computer program including instructions for causing a computer to perform a method of selectively controlling power to different functional units of the computer, the instructions comprising:
power-down instructions inserted in the computer-program in selected locations based on reducing power consumption and satisfying user-specified real-time constraints; and
wherein the power-down instruction in the selected locations reduce the power consumption during the execution of the code while satisfying the user-specified real-time constraints.

35. The medium of claim 34, wherein inserting power-down instructions in the computer-program in selected locations further comprises:
identifying one or more potential locations in the computer program where power-down instructions can be inserted;
selecting locations to insert the power-down instructions from the identified potential locations in the program based on satisfying user-specified real-time constraints; and
inserting the power-down instructions in the selected locations to reduce power consumption while running the computer program while satisfying the user-specified real-time constraints.

36. The medium of claim 35, wherein the code is written for a microprocessor including distinct functional units.

37. The medium of claim 35, wherein identifying potential locations comprises:
identifying the potential locations based on the functional units not being used in the potential locations, wherein the functional units not being used are determined based on functional unit usage transfer functions at each of the potential locations as specified in standard monotone data-flow frameworks.

38. The medium of claim 37, wherein identifying potential locations is accomplished by statically analyzing processor cycles prior to running the program.

39. The medium of claim 35, wherein selecting the identified potential locations on the computer program based on satisfying the user-specified real-time constraints, comprise:
running the computer program to generate power-profiling information associated with each of the identified potential locations;
running the computer program to generate execution path-profiling information associated with each of the identified potential locations;
assigning a weight factor to each of the identified potential locations based on the generated power-profiling and path-profiling information; and
selecting the locations to insert the power-down instructions from the identified locations based on the assigned weight factors and the user-specified real-time constraints.

40. The medium of claim 39, wherein running the program to generate path-profiling information to each of the identified potential locations further comprises:
generating running probability of each of the identified potential locations based on the generated path-profiling information.

41. The medium of claim 40, wherein assigning the weight factor comprises:
extracting potential energy savings for each of the identified potential locations using the generated power profile analysis information; and
assigning the weight factor to each of the identified potential locations based on the extracted potential energy savings and the generated running probability.

42. The medium of claim 41, wherein assigning the weight factor further comprises:
running the program to assign a first weight factor based on the extracted potential energy savings to each of the identified potential locations;
running the program to assign a second weight factor based on execution probability at each of the identified potential locations;
computing a product of the first and second weight factors for each of the identified potential locations;
calculating the weight factor for each of the identified potential locations based on the computed product of the first and second weight factors; and
assigning the calculated weight factor to each of the identified potential locations.

43. The medium of claim 35, wherein user-specified real-time constraints comprise:
the number of power-down instructions that can be inserted in a running path including one or more identified potential locations.

44. The medium of claim 43, further comprising:
inserting power-up instructions in the program to restore at least one functional unit to a ready state powered-down by the inserted power-down instructions.
